(19) United States
(12) Patent Application Publication
(10) Pub. No.: US 2026/0060190 A1
(43) Pub. Date: Mar. 5, 2026

(54) Tree Watering Ring and Using Method Thereof

(71) Applicant: Greenpros Company Limited, Taipei City (TW)

(72) Inventor: Yee-Hsian Li, Taipei City (TW)

(21) Appl. No.: 18/954,845

(22) Filed: Nov. 21, 2024

(30) Foreign Application Priority Data
Aug. 29, 2024 (TW) 113132521

(51) Int. Cl. A01G 27/02; A01G 13/02

(52) U.S. Cl. CPC A01G 27/02; A01G 13/31

(57) ABSTRACT

The present application provides a tree watering ring used for plant irrigation. A main body of the tree watering ring including a weed control cloth, a water-permeable cloth and a water-retaining material. The weed control cloth is located on one side of the main body, made of opaque and UV-resistant material, and has a water-injection hole equipped with a closing device. The water-permeable cloth is located on the other side of the main body, which is a double-sided permeable structure that can absorb ground moisture or release moisture into the soil. An accommodation space is formed between the water-permeable cloth and the weed control cloth, which is filled with the water-retaining material for absorbing external moisture or releasing moisture. The main body is placed around the roots of plants to adjust the soil moisture content and release the moisture from the water-retaining material when the soil moisture is low.

### CROSS-REFERENCE TO RELATED APPLICATION

This application claims the priority of Taiwanese patent application No. 113132521, filed on Aug. 29, 2024, which is incorporated herewith by reference.

### BACKGROUND OF THE INVENTION

### 1. Field of the Invention

The present invention relates generally to a field of plant irrigation device, and more particularly, to a tree watering ring that helps plants replenish and retain water through polymer water-retaining materials.

### 2. the Prior Arts

When planting plants, regular irrigation is integral to a plant's growth. Traditional irrigation methods require manual watering at regular intervals, which is not only requires manual labor, but also inefficient in utilizing water resources. The water irrigated onto the soil will only seep into the soil once the upper layer is saturated with water. However, while watering the upper layer, most of the water will either runoff or evaporate into the air. Therefore, more than half of the water used for irrigation is wasted, and only a small portion of it is utilized by plants. To conserve water, we can supply a continuous but small amount of water towards the root zone of the plant, thereby increasing watering efficiency while reducing the amount of water loss through runoff or evaporation.

The current mainstream method is to use automatic sprinkler irrigation or drip irrigation devices to supply water. In some areas where it is inconvenient to connect water pipes, alternative devices such as watering bags will be used. The known watering bags have a water storage device and a control valve. The control valve can be used to adjust the flow rate and extend the water supply time to between 5 and 9 hours to prevent a large amount of water from entering the soil and being lost through runoff or evaporation.

Although the known watering bag reduces the irrigation workload, people can extend the time between each irrigation, and because a large amount of water can be replenished to the water storage device at one time, the number of water replenishments is reduced. However, known watering bags utilize the water pressure in the water storage device to naturally discharge the stored water. When the water level in the water storage device decreases, the reduction in water pressure will cause the flow rate to decrease, resulting in unstable irrigation water volume.

When too much water is added at one time during irrigation, the soil water content will be too high, which may cause plant roots to soak. In addition, the known watering bag will continue to provide water even when it rains, and the abundant water from the rain is not used to replenish water, which makes the known watering bag unable to be used in places where there is no one to look after it for a long time or where it is inconvenient to replenish water.

In addition, after the trees are planted, many weeds will grow in the root zone. When using a lawn mower to remove weeds, the lawn mower may accidentally cut the trunk of the tree, causing damage to the bark, affecting the transport of water and nutrients, and even causing the death of the tree. Therefore, it is necessary to put a plastic tube on the base of the trunk to protect the trunk from being injured during weeding. However, these plastic pipes are not only unsightly, but also become entangled in the tree trunks and endanger the trees as they grow.

In view of the fact that weeding after tree planting is prone to cut the trunk and the aforementioned shortcomings of known watering bags, devices able to address these issues are the current pursuit of related industry and target customers.

### SUMMARY OF THE INVENTION

A primary objective of the present invention is to provide a watering ring for replenishing water for plants, which is a device wherein the moisture content in the soil is adjusted by a water-retaining material contained therein, and the water is stored through a permeable cloth when the soil humidity is high and is released to plant roots when there is a water shortage.

Another objective of the present invention is to automatically replenish moisture and extend the use time of the watering ring by using the water-retaining material to absorb environmental moisture to replenish the moisture of the watering ring when the external environmental humidity is high. When it rains, the watering ring can also absorb rainwater or water irrigated from the weed control cloth. When the external environment humidity is low, the water-retaining material will release water to flow into the soil through the permeable cloth, providing plants with necessary moisture.

Another objective of the present invention is to inhibit the growth of weeds by covering the soil surface of plant roots, and to reduce the rate at which water on the soil surface evaporates directly into the atmosphere without passing through the plants.

In order to achieve the aforementioned objectives, the present invention provides a tree watering ring, comprising a main body which further comprising: a weed control cloth, forming one side of the main body and made of opaque and UV-resistant material, having a water-injection hole with a closing device; a water-permeable cloth, forming the other side of the main body, having a double-sided permeable structure able to absorb ground moisture or release moisture from a water-retaining material to the soil, the edge of the water-permeable cloth and the edge of the weed control cloth being joined and sealed to form the main body, and an accommodation space being formed between the water-permeable cloth and the weed control cloth; and a water-retaining material, filling the accommodation space to absorb external moisture or release moisture; wherein, the water-injection hole communicates the accommodation space to the outer environment.

In a preferred embodiment of the present invention, the tree watering ring is placed on the soil surface of the plant roots, and the moisture in the water-retaining material is released by the osmotic pressure difference when the soil is short of water, and the moisture in the external environment is absorbed when the external environment humidity is high.

Specifically, the user can directly pour water or the water-retaining material into the accommodation space through the water-injection hole to replenish the moisture in the water-retaining material or replenish the water-retaining material, and the excess water will be discharged through the permeable cloth. Users can place the watering ring at the roots of plants and use the opaque weed control cloth to block sunlight at the roots of the plants to prevent weeds from growing. And due to the shading effect of the watering ring, the evaporation rate of surface soil water at the plant roots will be reduced.

In a preferred embodiment of the present invention, the main body of the tree watering ring is an integrally formed C-shaped ring with an opening. The main body can be placed around the plant by inserting the trunk of the tree through the opening.

Preferably, the main body can be in different shapes to correspond to different needs, such as semicircle, square or rectangle.

In a preferred embodiment of the present invention, the main body is C-shaped and also has a pair of buckles arranged on the main body on both sides of the opening; after the main body is installed around the plant, the pairs of buckles can be overlapped and then nails can be passed through, so that the main body is fixed to the ground. Furthermore, the opening cannot be opened because the pairs of buckles are driven through by nails, so that the main body does not become detached from the tree surroundings.

In a preferred embodiment of the present invention, the closing device is an adhesive patch or an opening cover; the water-injection hole is an opening directly disposed on the weed control cloth, and then the opening cover or the adhesive patch is provided to close the water-injection hole to avoid water loss.

Preferably, the adhesive patch is a tape or Velcro felt structure.

Preferably, the adhesive patch is made of the same material as the weed control cloth.

In a preferred embodiment of the present invention, the opening cover is a Velcro felt structure or a water plug; the opening cover can be opened to replenish the moisture of the water-retaining material by pouring water directly into the water-injection hole, and after replenishing, the cover can also be closed to avoid water loss.

In a preferred embodiment of the present invention, the weed control cloth is made of water-permeable or one-sided water-permeable and breathable material; the water-retaining material can absorb moisture condensed on the surface of the main body through the weed control cloth or directly from the ground.

Preferably, the water-retaining material is a high-diffusivity polymer water-retaining agent, which provides a diffusion channel when adding water or water-retaining agent to increase the rate of water diffusion and increase the water absorption effect.

Preferably, the water-retaining material is polyacrylate, and salts are added to enhance the water-retaining material dehydrate.

Preferably, long-lasting fertilizers or pesticides are added to the accommodation space to improve the irrigation effect.

Preferably, the water-retaining material is made of non-toxic and naturally decomposable materials.

The effect of the tree watering ring of the present invention is to achieve a humidity balance between the soil and the atmosphere, reduce soil moisture loss, and enable plants planted in the soil to continuously receive moisture.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic top view of the first embodiment of the present invention;

FIG. 2 is a schematic top view of the second embodiment of the present invention;

FIG. 3 is a schematic view of the A-A section line in FIG. 2;

FIG. 4 is a schematic top view of the third embodiment of the present invention;

FIG. 5 is a schematic view of the B-B section line in FIG. 4; and

FIG. 6 is a schematic top view of the fourth embodiment of the present invention.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

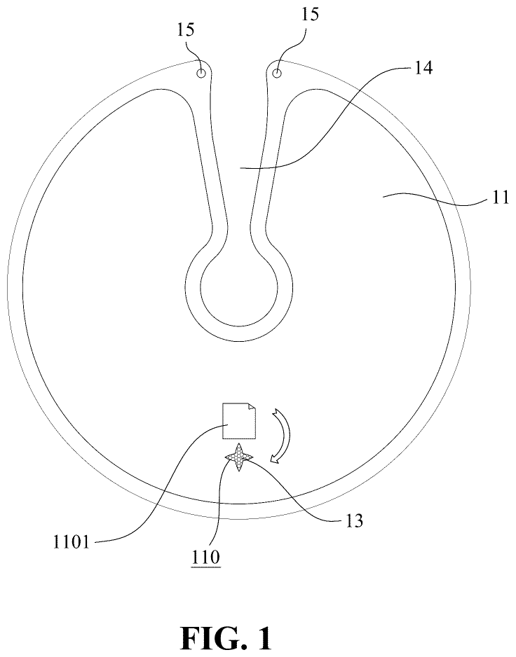

FIGS. 1 to 5 are schematic views of tree watering rings according to different embodiments of the present invention. As shown in the schematic top view of the first embodiment of the present invention in FIG. 1, the tree watering ring according to the first embodiment of the present invention has a main body 1, which further includes: a weed control cloth 11, a water-permeable cloth 12, and a water-retaining material 13. Wherein, the weed control cloth 11 forms one side of the main body 1, is made of an opaque and UV-resistant material, and has a water-injection hole 110 equipped with a closing device. The water-permeable cloth 12 forms the other side of the main body 1 and has a double-sided water-permeable structure, which can absorb ground moisture or release water to the soil. The edge of the water-permeable cloth 12 and the edge of the weed control cloth 11 are joined and sealed, so that an accommodation space 130 is formed between the water-permeable cloth 12 and the weed control cloth 11. The closing device can be opened for the accommodation space 130 to communicate with the external environment through the water-injection hole 110. The water-retaining material 13 is filled in the accommodating space 130 to absorb external moisture or release moisture to the external environment.

In a preferred application, the main body 1 is placed on the soil surface of the plant roots, the water-permeable cloth 12 is in contact with the ground, and the weed control cloth 11 is facing away from the ground. Since the water-permeable cloth 12 has a double-sided permeable structure, when the soil moisture is low and an osmotic pressure difference is formed, the moisture contained in the water-retaining material 13 will penetrate through the water-permeable cloth 12 into the soil. As such, the soil can maintain a certain humidity to irrigate the plants.

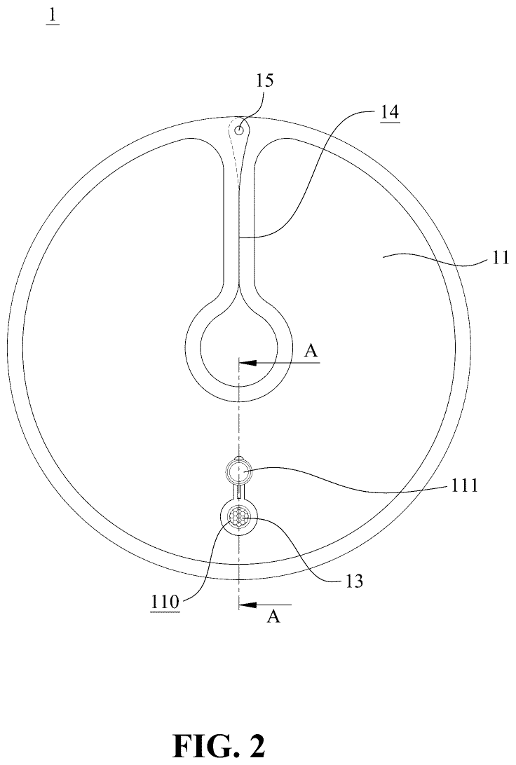

As shown in the top view of the second embodiment of the present invention in FIGS. 1 and 2, the closing device is an adhesive patch 1101 or an opening cover 111. The water-injection hole 110 is an opening formed by directly cutting or drilling at a suitable position of the weed control cloth 11, and an adhesive patch 1101 is used to close the water-injection hole 110 or an opening cover 111 is provided to close the water-injection hole 110 to avoid water loss.

Specifically, the adhesive patch 1101 is a cloth material that has the effect of sticking to the main body 1. The cloth material can be directly adhered to the main body 1 through an adhesive structure.

Preferably, the cloth material of the adhesive patch 1101 is the same as the weed control cloth 11.

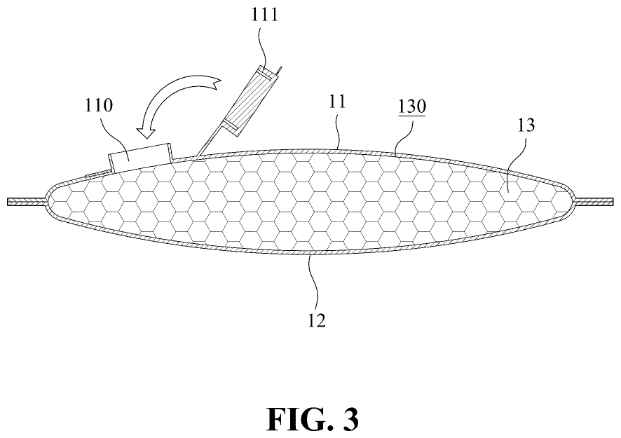

As shown in the A-A cross-sectional schematic view of the second embodiment of the present invention in FIG. 2 and FIG. 3, specifically, the user can open the opening cover 111 and directly replenish the water-retaining material 13 through the water-injection hole 110 or add water to the accommodation space 130 so as to replenish the moisture of the water-retaining material 13; after adding water, the opening cover 111 is closed to avoid leakage or moisture loss of the water-retaining material 13. When the main body 1 is placed at the root of a plant, different working modes will occur depending on the relative humidity between the external environment and the water-retaining material 13. When the humidity of the external environment is low, a sufficient osmotic pressure difference is formed to cause water to be released from the water-retaining material 13 through the water-permeable cloth 12, thereby replenishing and maintaining soil moisture. When the humidity of the external environment is high, such as when rain or temperature changes increase the humidity, the water-retaining material 13 will absorb moisture from the external environment through the water-permeable cloth 12 to store the moisture inside the accommodation space.

Furthermore, the opaque weed control cloth 11 will block sunlight, thereby inhibiting the growth of weeds below the main body 1. At the same time, the opaque weed control cloth 11 reduces the rate at which water in the soil at the plant roots evaporates directly into the atmosphere, allowing the water to be better retained in the soil.

As shown in the top view of the third embodiment of the present invention in FIGS. 1, 2 and 4, the main body 1 is an integrally formed C-shaped ring and also has an opening 14. The trunk of the plant can be inserted into the C-shaped main body 1 through the opening 14 so as to be installed around the roots of the plant.

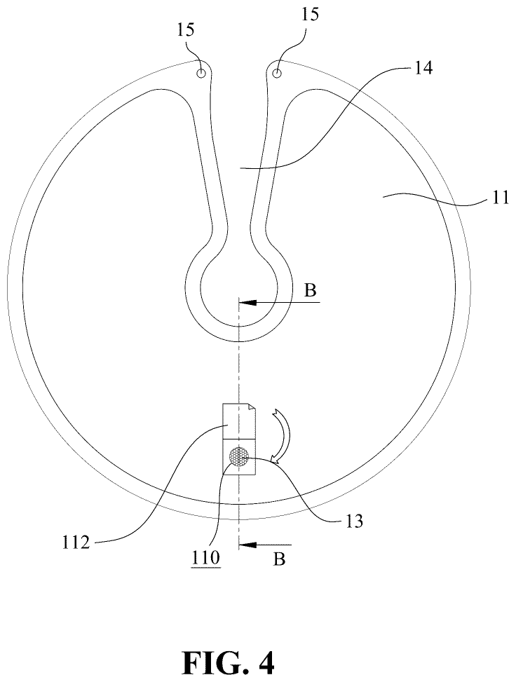

As shown in FIG. 4, the main body also has a pair of buckles 15, which are provided on the main body 1 on both sides of the opening 14. When the main body 1 is installed around the plant roots, the main body 1 is fixed to the ground by overlapping pairs of buckles 15 and stringing them together with nails. At the same time, since the pairs of buckles 15 are overlapped and strung together by nails, the opening 14 will be restricted from being opened so that the main body 1 will not be separated from the roots of the plant.

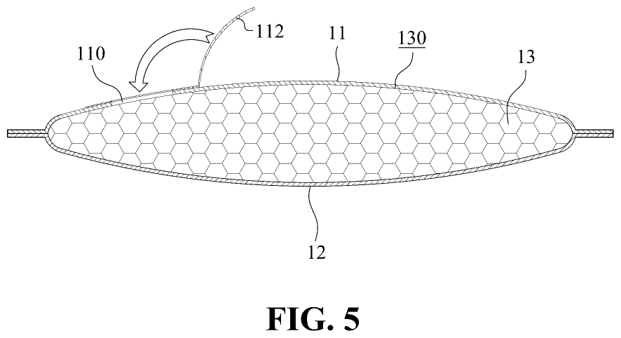

FIG. 5 is a schematic cross-sectional view along the line B-B of the third embodiment of the present invention, in which the opening cover 111 is a water plug.

Preferably, the adhesive patch 1101 can be Velcro felt 112 or duct tape.

In a preferred embodiment of the present invention, the weed control cloth 11 is made of water-permeable or one-sided water-permeable and breathable material. When the air humidity is high, the water-retaining material 13 can absorb moisture condensed on the surface of the weed control cloth 11 through the weed control cloth 11; or it can absorb moisture directly from the ground.

Specifically, when the ground moisture comes into contact with the main body 1, the moisture will be sucked into the accommodation space 130 through capillary effect, and then be absorbed by the water-retaining material 13. When the temperature difference of the air changes greatly, moisture will easily condense on the surface of the main body 1. The condensed moisture will be absorbed into the accommodation space 130 through the weed control cloth 11 and then absorbed by the water-retaining material 13.

Furthermore, when the tree watering ring is used in a city or an area prone to flooding, the weed control cloth 11 can be made of water-impermeable or air-impermeable material to reduce water evaporation and prolong the replenishment time. When the tree watering ring is used in the wild or in areas where it is difficult to replenish water, the weed control cloth 11 can be made of water-permeable or one-sided water-permeable material, so that the water-retaining material 13 can directly replenish moisture from the environment.

Preferably, the material of the weed control cloth 11 can be: polyethylene (PE) non-woven fabric or heat-pressed non-woven fabric.

Preferably, the water-retaining material 13 a high-diffusivity polymer water-retaining agent, which provides a diffusion channel when adding water or water-retaining agent to increase the rate of water diffusion and increase the water absorption effect.

Preferably, the water-retaining material 13 is a highly water-absorbent polymer, and salts are added to enhance dehydration to facilitate the recovery of water.

Specifically, the water retaining material 13 can be polyacrylate, such as sodium polyacrylate. When the water-retaining material 13 comes into contact with water, the sodium ions will dissociate, causing the carboxyl groups of the polyacrylic acid to form valence bonds with water molecules, thereby absorbing water molecules. However, when there are other cations with a positive valence of more than 2 in the aqueous solution, the carboxyl group of the polyacrylic acid will first combine with the cations, thereby reducing the water absorption effect of the water-retaining material 13.

Therefore, when it is necessary to dehydrate the tree watering ring of the present invention to facilitate recycling, various salts, such as organic salts, inorganic salts or polyvalent metal salts, can be used to dehydrate the water retaining material 13.

Preferably, the water-retaining material 13 can be dehydrated using sodium chloride to facilitate recycling.

Chinese Patent No. CN104245119B discloses a method for dehydrating super absorbent polymers using alkali metal salt solutions.

Preferably, the opening cover 111 can add long-term fertilizer or pesticide to the accommodation space 130 to improve the farming effect.

Preferably, the material of the main body 1 can be naturally decomposed.

In a preferred embodiment of the present invention, when plants are planted in tree holes, users can use tree watering rings of corresponding sizes or shapes, such as: semicircle, square or rectangle, according to the size or shape of the plants, and place them on the tree holes to irrigate the plants.

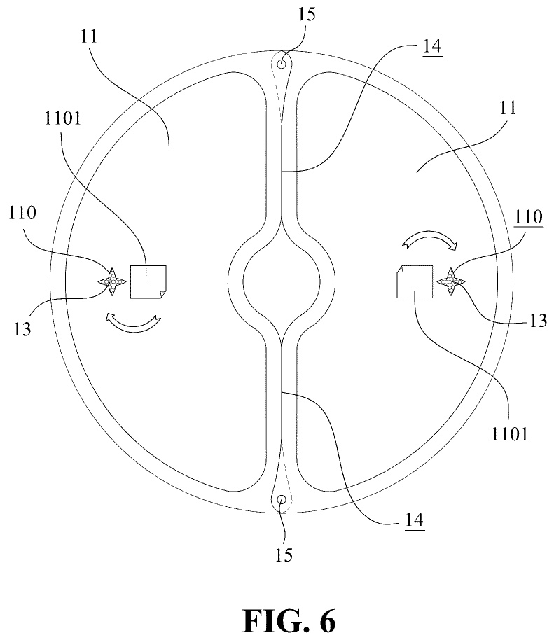

In a preferred embodiment of the present invention, as shown in the top view of the fourth embodiment of the present invention in FIG. 6, the main body 1 can be semicircular, and two main bodies 1 are used to surround it at the same time for installation around plant roots. The main bodies 1 can be connected to each other by nails passing through the buckles 15.

Preferably, a plurality of main body 1 can be installed around the roots of the plants as needed, and are all connected by nails passing through the buckles 15.

Although the present invention has been described with reference to the preferred embodiments thereof, it is apparent to those skilled in the art that a variety of modifications and changes may be made without departing from the scope of the present invention which is intended to be defined by the appended claims.

1. A tree watering ring, comprising:
a main body, being a C-shaped ring with an opening, and the main body comprising:
a pair of buckles, arranged on the main body on both sides of the opening;
a weed control cloth, forming one side of the main body and made of opaque and UV-resistant material, having a water-injection hole;
a water-permeable cloth, forming the other side of the main body, having a double-sided permeable structure, the edge of the water-permeable cloth and the edge of the weed control cloth being joined and sealed to form the main body, and an accommodation space being formed between the water-permeable cloth and the weed control cloth; and
a water-retaining material, filling the accommodation space to absorb external moisture or release moisture; and
a closing device, disposed at the water-injection hole, the closing device being an adhesive patch;
wherein, the main body can be placed on a tree hole before filling with water, and the size and shape of the main body can be changed according to the size and shape of plants to be planted in the tree hole;
wherein, after the main body is installed around the plant, the pairs of buckles can be overlapped and then nails can be passed through, so that the main body is fixed to the ground;
wherein, when the external humidity is greater than the humidity of the water-retaining material, the water-retaining material absorbs external moisture through the water-permeable cloth to replenish the moisture of the water-retaining material; and
wherein, the water-permeable cloth contacts the ground so that the water-injection hole is located above and directly replenishes water to the water-retaining material through the water-injection hole, and after the replenishment is completed, the water-injection hole is closed by the closing device to reduce water loss.

2. (canceled)

3. (canceled)

4. (canceled)

5. The tree watering ring according to claim 1, wherein the adhesive patch is a hook and loop fastener or a duct tape.

6. The tree watering ring according to claim 5, wherein the weed control cloth is made of UV-resistant material, and is water-permeable or one-sided water-permeable and air-permeable material, so that the water-retaining material can absorb moisture condensed on the surface of the main body, or absorb moisture directly from the ground.

7. The tree watering ring according to claim 5, wherein the weed control cloth is made of UV-resistant material, and is water-impermeable or air-impermeable material used to reduce water loss through evaporation of the water-retaining material.

8. The tree watering ring according to claim 1, wherein the water-retaining material is a highly diffusive polymer water-retaining agent used to increase the rate of water diffusion.

9. The tree watering ring according to claim 8, wherein the water-retaining material has a property that is able to completely release water using sodium chloride.

10. A method of using a tree watering ring, the tree watering ring comprising:
a main body, being a C-shaped with an opening, and the main body comprising:
a pair of buckles, arranged on the main body on both sides of the opening;
a weed control cloth, forming one side of the main body and made of opaque and UV-resistant material, having a water-injection hole;
a water-permeable cloth, forming the other side of the main body, having a double-sided permeable structure, the edge of the water-permeable cloth and the edge of the weed control cloth being joined and sealed to form the main body, and an accommodation space being formed between the water-permeable cloth and the weed control cloth; and
a water-retaining material, filling the accommodation space to absorb external moisture or release moisture; and
a closing device, disposed at the water-injection hole, the closing device being an adhesive patch;
wherein, sodium chloride is used on the water-retaining material to completely release water to facilitate water recovery;
the method comprising the steps of:
installing the main body of the tree watering ring around the trunk of the plant through the opening;
opening the closing device to inject water through the water-injection hole to the water-retaining material; and
when recycling the tree watering ring, adding sodium chlorine to the water-retaining material to completely release water from the water-retaining material, so as to facilitate the recycling of the tree watering ring.
